(19) United States
(12) Patent Application Publication
(10) Pub. No.: US 2004/0220998 A1
(43) Pub. Date: Nov. 4, 2004

(54) System and method of building wireless component applications

(76) Inventors: Michael Shenfield, Richmond Hill (CA); Viera Bibr, Kilbride (CA); Brindusa L. Fritsch, Toronto (CA); Bryan R. Goring, Milton (CA); Robert Kline, Richmond Hill (CA); Kamen B. Vitanov, Toronto (CA)

Correspondence Address: Grant Tisdall, Gowling Lafleur Henderson LLP, Suite 4900, Commerce Court West, Toronto, M5J 1L3, CA

(21) Appl. No.: 10/744,676

(22) Filed: Dec. 23, 2003

Related U.S. Application Data
(60) Provisional application No. 60/436,011, filed on Dec. 26, 2002.
(60) Provisional application No. 60/503,706, filed on Sep. 17, 2003.

(51) Int. Cl. G06F 15/16

(52) U.S. Cl. 709/201

(57) ABSTRACT

A system and method of building wireless component applications are provided. Component applications are executed on mobile communication devices, which communicate with a web service via a wireless network and the Internet. The component applications comprise data components, presentation components, and message components, which are written in XML code. The component applications further comprise workflow components which are written in a subset of ECMAScript, and are embedded in the XML code.

This application claims the benefit of U.S. provisional 60/436,011 filed Dec. 26, 2002, the entire disclosure of which is herein incorporated by reference, and further claims the benefit of U.S. provisional 60/503,706 filed Sep. 17, 2003, the entire disclosure of which is herein incorporated by reference.

### BACKGROUND

This application relates generally to wireless communication and specifically to software for mobile communication devices.

There is a continually increasing number of mobile communication devices in use today, such as mobile telephones, PDAs with wireless communication capabilities, and two-way pagers. Software applications which run on these mobile communication devices increase their utility. For example, a mobile phone may include an application which retrieves the weather for a range of cities, or a PDA may include an application that allows a user to shop for groceries. These software applications take advantage of the mobility of these devices and connectivity to a wireless network in order to provide timely and useful services to users, regardless of where the users are. However, due to the restricted resources of mobile communications devices, and the complexity of delivering data wirelessly to a mobile communication device, developing software applications for mobile communications devices remains a difficult and time-consuming task.

Currently, mobile communication devices are configured to communicate with Web Services through Internet based Browsers and/or native applications. Browsers have the advantage of being adaptable to operate on a cross-platform basis for a variety of different devices, but have a disadvantage of requesting pages (screen definitions in HTML) from the Web Service, which hinders the persistence of data contained in the screens. A further disadvantage of Browsers is that the screens are rendered at runtime, which can be resource intensive. Native applications have the advantage of being developed specifically for the type of mobile device, thereby providing a relatively optimized application program for each runtime environment. However, native applications have disadvantages of not being platform independent, thereby necessitating the development of multiple versions of the same application, as well as being relatively large in size, thereby taxing the memory resources of the mobile device. Further, application developers need experience with programming languages such as Java and C++ to construct these hard coded native applications. There is a need for application programs that can be run on web service clients having a wide variety of runtime environments, as well as having a reduced consumption of mobile device resources.

Systems and methods disclosed herein provide a component based application environment to obviate or mitigate at least some of the above presented disadvantages.

### SUMMARY

Current application programs are not adaptable to be run on clients having a wide variety of runtime environments, and can undesirably consume too much of mobile device resources. Browsers are an application program that have a disadvantage of requesting pages (screen definitions in HTML) from a Web Service, which hinders the persistence of data contained in the screens. A further disadvantage of Browsers is that the screens are rendered at runtime, which can be resource intensive. Native applications are a further example of current application programs which have disadvantages of not being platform independent, thereby necessitating the development multiple versions of the same application, as well as being relatively large in size, thereby taxing the memory resources of the mobile device. Contrary to current application programs, a system of building and communicating with wireless component applications is provided. The system comprises component applications which execute on mobile communication devices, which communicate with a web service via a wireless network and the Internet. The component applications comprise one or more data components, presentation components, and/or message components, which are written in a structured definition language such as XML code. The component applications can further comprise workflow components which contain a series of instructions such as written in a subset of ECMAScript, and can be embedded in the XML code in some implementations. A method of building wireless component applications is also provided. The method comprises steps of creating data components, creating presentation components, and creating message components. The data, presentation, and message components can be written in XML in some implementations. The method further comprises tying together the data, presentation, and message components with workflow components written as a set of instruction in a programming language such as subset of ECMAScript.

Accordingly, a method of interacting with a web service by a mobile communication device over a network is provided. The method comprises the steps of: receiving a request network message for establishing communication between the web service and the communication device; sending in response to the request network message a component application program including a plurality of components, a first set of the components having descriptors expressed in a structured definition language and a second set of the components being expressed as a series of instructions, the components being configured for provisioning by a runtime environment of the communication device to produce an executable version of the component application program configuring the device as a web client of the web service; wherein execution of the executable version provides for a subsequent exchange of information over the network between the web service and the communication device.

Also disclosed is a mobile communication device configured for interacting over a network with a web service using an executable version of a component application program including a plurality of components. The device comprises; a device infrastructure for operating the mobile device including a processor and an associated memory for executing the executable version; a user interface coupled to the device infrastructure having an input device and an output device configured for communication with the executable version; a wireless transceiver coupled to the device infrastructure and configured for communicating with the network; and a runtime environment for coordinating execution of the executable version for configuring the device as a web client of the web service, the runtime environment configured for interaction with a first set of the components having descriptors expressed in a structured definition language and a second set of the components being expressed as a series of instructions; wherein the execution of the executable version provides for a subsequent exchange of information over the network between the web service and the communication device over the network.

A computer program product for configuring a mobile communication device for interacting over a network with a web service using an executable version of a component application including a plurality of components is further disclosed. The computer program product comprises: a computer readable medium; a runtime environment module stored on the computer readable medium for coordinating execution of the executable version for configuring the device as a web client of the web service, the runtime environment configured for interaction with a first set of the components having descriptors expressed in a structured definition language and a second set of the components being expressed as a series of instructions; wherein the execution of the executable version provides for a subsequent exchange of information over the network between the web service and the communication device over the network.

Also disclosed herein is a server configured for providing a web service for interacting with a mobile communication device over a network. The server comprises: a network interface for receiving a request network message to establish communication between the web service and the communication device; a component application program coupled to the network interface for sending in response to the request network message, the component application program including a plurality of components, a first set of the components having descriptors expressed in a structured definition language and a second set of the components being expressed as a series of instructions, the components being configured for provisioning by a runtime environment of the communication device to produce an executable version of the component application program configuring the device as a web client of the web service; wherein execution of the executable version provides for a subsequent exchange of information over the network between the web service and the communication device.

There is also provided a mobile communication device configured for interacting over a network with a web service using an executable version of a component application program including a plurality of components. The device comprises; an infrastructure means for operating the mobile device to execute the executable version; a user interface means coupled to the infrastructure means configured for communication with the executable version; a transceiver means coupled to the device infrastructure and configured for communicating with the network; and a runtime means for coordinating execution of the executable version for configuring the device as a web client of the web service, the runtime means configured for interaction with a first set of the components having descriptors expressed in a structured definition language and a second set of the components being expressed as a series of instructions; wherein the execution of the executable version provides for a subsequent exchange of information over the network between the web service and the communication device over the network.

### BRIEF DESCRIPTION OF THE DRAWINGS

These and other features will become more apparent in the following detailed description in which reference is made to the appended drawings wherein:

FIG. 1 is a block diagram of a communication system;

FIG. 2 is a block diagram of a mobile communication device of FIG. 1;

FIG. 3 is a block diagram of a component application program of FIG. 2;

FIG. 4 is a block diagram illustrating an example component application of FIG. 3;

FIG. 5 is a flowchart illustrating a method of building the wireless component application of FIG. 3;

FIG. 6 is a flowchart of a method for communicating between a device and web service of FIG. 1;

FIG. 7 shows an example method of implementing the component application program of FIG. 3;

FIG. 8 shows a further example method of implementing the component application program of FIG. 3; and

FIG. 9 is a block diagram of a further example of the device of FIG. 2.

### DESCRIPTION

Network System

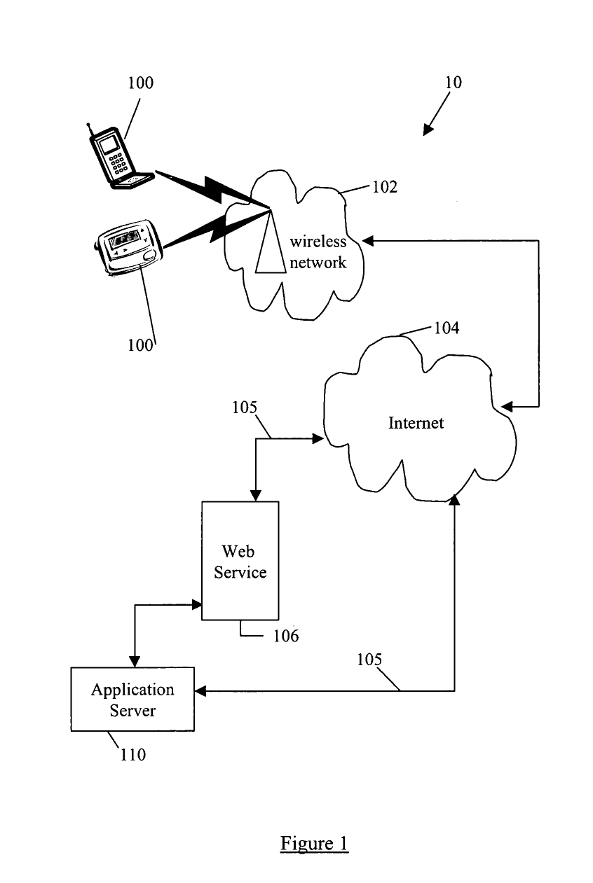

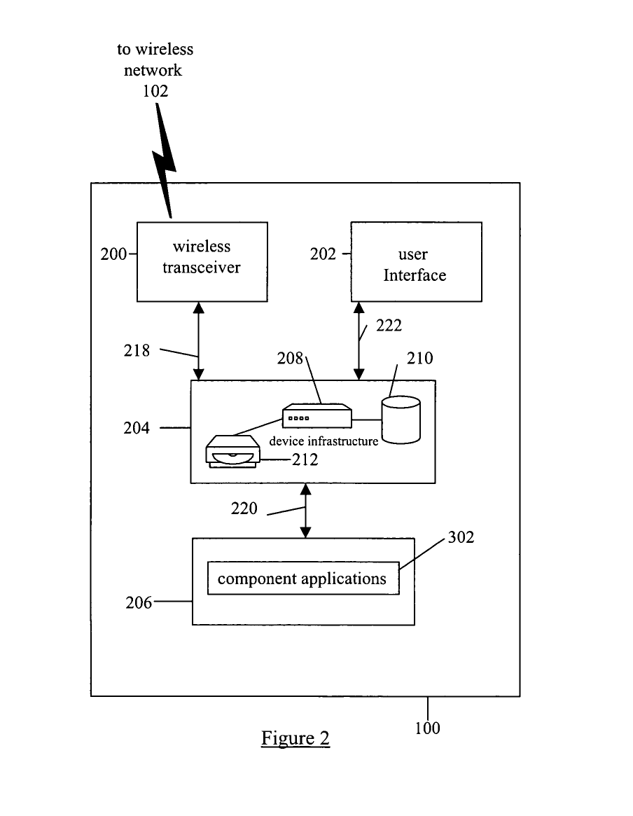

Referring to FIG. 1, a network system 10 comprises mobile communication devices 100 for interacting with one or more web services provided by a web server 106 via a coupled wireless network 102 and the Internet 104. The devices 100 transmit and receive requests/response messages 105, respectively, when in communication with the web services of the web server 106. The devices 100 can operate as web clients of the web services by using the requests/response messages 105 in the form of message header information and associated data content, for example requesting and receiving product pricing and availability from an on-line merchant. The web service is an example of a system with which client application programs 302 (see FIG. 2) on the communication devices 100 interact via the wireless network 102 and the Internet 104 in order to provide utility to users of the communication devices 100. The messages 105 sent between the communication devices 100 and the web service could traverse a message-map service (not shown) which converts the messages 105 between the differing formats used by the devices 100 and the web service.

For satisfying the appropriate requests/response messages 105, the web server 106 communicates with an application server 110 through various protocols (such as but not limited to HTTP and component API) for exposing relevant business logic (methods) to client application programs 302 (see FIG. 2) once provisioned on the devices 100. The application server 110 can also contain the web server 106 software, such that the web server 106 can be considered a subset of the application server 110. The application programs 302 of the devices 100 can use the business logic of the application server 110 similarly to calling a method on an object (or a function). It is recognized that the client application program 302 can be downloaded/uploaded in relation to the application server 110, through the messages 105 via the network 102, 104, directly to the devices 100. It is further recognized that the devices 100 can communicate with one or more web servers 106 and associated application servers 110 via the networks 102, 104. It is also recognized that the devices 100 could be directly coupled to the application servers 110, thereby bypassing the web servers 106, if desired.

Server Environment

Referring to FIG. 1, the web server 106 provides information messages 105 which are used by the client application programs 302 on the communication devices 100. Alternatively, or in addition, the web server 106 may receive and use the information messages 105 provided by the client application programs 302 executed on the communication devices 100, or perform tasks on behalf of client application programs 302 executed on the communication devices 100. The web service can be defined as a software service of the web server 106, which can implement an interface expressed using Web Services Description Language (WSDL) registered in Universal Discovery Description and Integration (UDDI), and can communicate through messages 105 with client devices 100 by being exposed over the Internet 104 through an appropriate protocol such as the Simple Object Access Protocol (SOAP). In some implementations, SOAP is a specification that defines the XML format for the messages 105, including a well-formed XML fragment enclosed in SOAP elements. Other parts of SOAP specify how to represent program data as XML and how to use SOAP to do Remote Procedure Calls (RPC). These optional parts of SOAP are used to implement RPC-style applications where a SOAP request message 105 containing a callable function, and the parameters to pass to the function, is sent from the client device 100, and the server 106 returns the response message 105 with the results of the executed function. SOAP also supports document style applications where the SOAP message 105 is a wrapper around an XML document. A further optional part of SOAP defines the HTTP binding (i.e. header), whereas some SOAP implementations support MSMQ, MQ Series, SMTP, or TCP/IP transport protocols. Alternatively, the web service may use other known communication protocols, message 105 formats, and the interface may be expressed in other web services languages than described above. Accordingly, the services supplied by the server 106 are utilized by the user of the devices 100 over the network 102, 104.

Client Environment

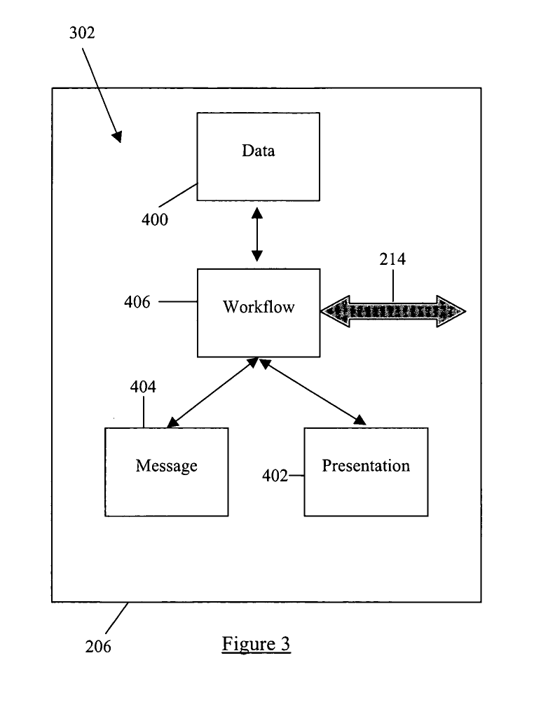

Referring to FIG. 2, the component applications 302 are software applications which can be written, for example, in eXtensible Markup Language (XML) and a subset of ECMAScript, as described in FIG. 3. XML and ECMAScript are standards-based languages which allow software developers to develop the component applications 302 in a portable and platform-independent way. The component applications 302 are transmitted over-the-air via the wireless network 102 and loaded into a memory module 210 of a device infrastructure 204. Alternatively, the component applications 302 may be loaded via a serial connection, a USB connection, or a short-range wireless communication system such as IR, 802.11(x) and/or Bluetooth™ onto the device 100. Once loaded onto the mobile communication device 100, the component applications 302 are executed by a component framework 206 on the mobile communication device 100, which converts component applications 302 into native code which is executed by the processor in the device infrastructure 204. Alternatively, the component applications 302 may be executed as native code or interpreted by another software module or operating system on the mobile communication device 100, which provides the component framework 206 as a native runtime environment, hereafter referred to generically by reference numeral 206.

Referring again to FIGS. 1 and 2, the client runtime environment 206 provided by the devices 100 can be configured to make the devices 100 operate as web clients of the web services (of the web server 106). The client runtime environment 206 of the devices 100 is preferably capable of generating, hosting and executing the client application programs 302 (which are in the form of component applications —see FIG. 3) on the device 100. Further, specific functions of the client runtime environment 206 can include such as but not limited to support for language, coordinating memory allocation, networking, management of data during I/O operations, coordinating graphics on an output device of the devices 100 and providing access to core object oriented classes and supporting files/libraries. Examples of the runtime environments 206 implemented by the devices 100 can include such as but not limited to Common Language Runtime (CLR) by Microsoft and Java Runtime Environment (JRE) by Sun Microsystems.

The terminal runtime environment 206 of the devices 100 preferably supports the following basic functions for the resident executable versions of the client application programs 302, such as but not limited to:

provide a communications capability to send messages 105 to the Web Services of the web server 106 connected via the network 102, 104;

provide data input capabilities by the user on an input device of the devices 100 to supply data parts for Web Services' outgoing messages 105 (messages to the service) of the web server 106;

provide data presentation or output capabilities for Web Services' response messages 105 (incoming messages) or uncorrelated notifications of the web server 106 on the output device;

provide data storage services to maintain local client data in the memory module 210 (see FIG. 2) of the device 100; and

provide an execution environment for a scripting language for coordinating operation of the application components 400, 402, 404, 406 (see FIG. 3) of the client application programs 302.

Therefore, the native client terminal runtime environment 206 provides an interface for the client application programs 302 and to the device 100,116 functionality of the processor 208 and associated operating system of the device infrastructure 204. The runtime environment 206 preferably supplies a controlled, secure and stable environment on the device 100, in which the component application programs 302 execute. The runtime environment 206 provisions the definitions of the components 400, 402, 404, 406 to create the actual web client specific for each respective device infrastructure 204 of the communication devices 100.

Communication Device

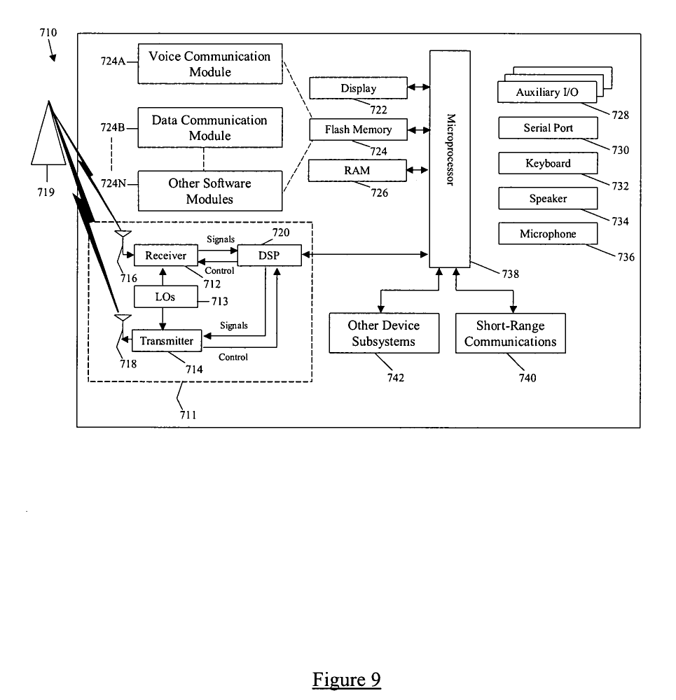

Referring to FIGS. 1 and 2, the communication devices 100 are devices such as but not limited to mobile telephones, PDAs, two-way pagers and dual-mode communication devices (see FIG. 9). The devices 100 include a network connection interface such as a wireless transceiver 200 coupled via connection 218 to a device infrastructure 204. The wireless transceiver 200 is connectable during operation of the devices 100 to the network 102, 104, such as to the wireless network 102 by RF links, which enable the devices 100 to communicate with each other and with external systems (such as the web server 106) via the network 102, 104. The wireless transceiver 200 also helps the device 100 to coordinate the requests/response messages 105 between the client application programs 302 and the servers 106, 110. The network 102, 104 supports the transmission of data in the requests/response messages 10S between devices 100 and external systems, which are connected to the network 102, 104. The network 102, 104 may also support voice communication for telephone calls between the communication devices 100 and devices which are external to the network 102, 104. A wireless data transmission protocol can be used by the wireless network 102, such as but not limited to DataTAC, GPRS or CDMA. The connection between the wireless network 102 and the Internet 104 includes an Internet Gateway (not shown), which enables the messages 105 and associated data content to flow between the connected devices 100 and the web service of the server 106.

Referring again to FIG. 2, the devices 100 also have a user interface 202, coupled to the device infrastructure 204 by connection 222, to interact with a user (not shown). The user interface 202 includes one or more user input devices such as but not limited to a QWERTY keyboard, a keypad, a trackwheel, a stylus, a mouse, a microphone, and the user output device such as an LCD screen display and/or a speaker. If the screen is touch sensitive, then the display can also be used as the user input device as controlled by the device infrastructure 204. The user interface 202 is employed by the user of the device 100 to coordinate the requests/response message messages 105 over the system 10 (see FIG. 1) as employed by client application programs 302 executed in the runtime environment 206.

Referring again to FIG. 2, operation of the communication device 100 is enabled by the device infrastructure 204. The device infrastructure 204 includes a computer processor 208 and the associated memory module 210. The computer processor 208 manipulates the operation of the network interface 200, the user interface 202 and the runtime environment 206 of the communication device 100 by executing related instructions, which are provided by an operating system and client application programs 302 located in the memory module 210. Further, it is recognized that the device infrastructure 204 can include a computer readable storage medium 212 coupled to the processor 208 for providing instructions to the processor and/or to load/update client application programs 302 in the memory module 210. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 210. It should be noted that the above listed example computer readable mediums 212 can be used either alone or in combination.

Component Application Program

Referring to FIG. 3, a block diagram of the component application program 302 comprises the data components 400, the presentation components 402 and the message components 404, which are coordinated by workflow components 406 through communications 214 with the client runtime environment 206. The structured definition language can be used to construct the components 400, 402, 404 as a series of metadata records, which consist of a number of pre-defined elements representing specific attributes of a resource such that each element can have one or more values. Each metadata schema typically has defined characteristics such as but not limited to; a limited number of elements, a name of each element, and a meaning for each element. Example metadata schemas include such as but not limited to Dublin Core (DC), Anglo-American Cataloging Rules (AACR2), Government Information Locator Service (GILS), Encoded Archives Description (EAD), IMS Global Learning Consortium (IMS), and Australian Government Locator Service (AGLS). Encoding syntax allows the metadata of the components 400, 402, 404 to be processed by the device infrastructure 204 (see FIG. 2), and encoding schemes include such as but not limited to XML, HTML, XHTML, XSML, RDF, Machine Readable Cataloging (MARC), and Multipurpose Internet Mail Extensions (MIME). The client runtime environment 206 operates on the metadata descriptors of the components 400, 402, 404 to provision an executable version of the application program 302.

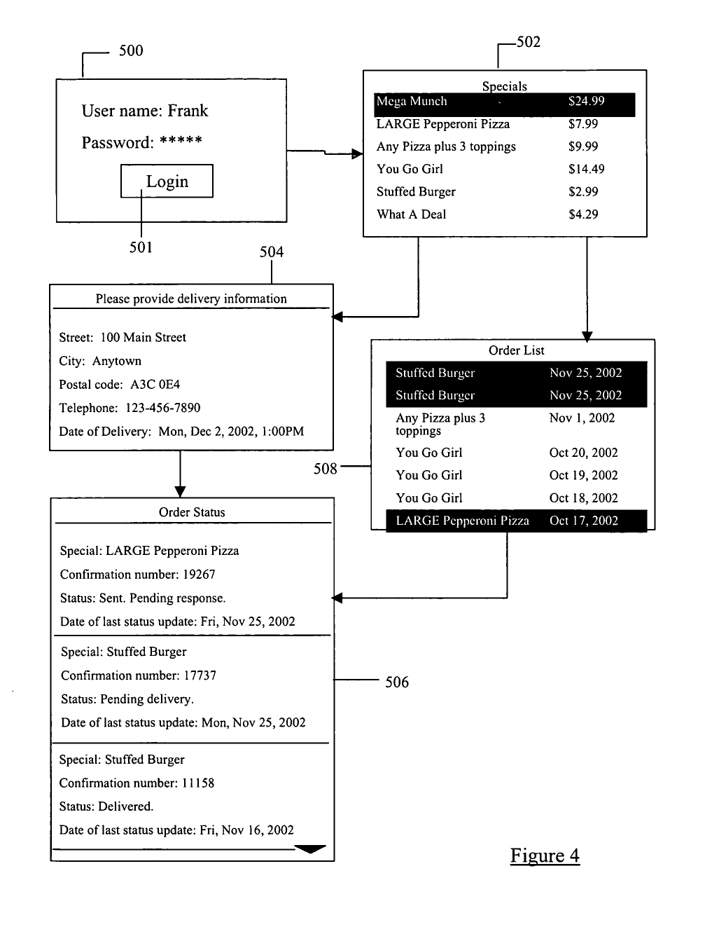

Referring again to FIG. 4, the data components 400 define data entities which are used by the component application program 302. Examples of data entities which data components 400 may describe are orders, users, and financial transactions. Data components 400 define what information is required to describe the data entities, and in what format the information is expressed. For example, the data component 400 may define such as but not limited to an order which is comprised of a unique identifier for the order which is formatted as a number, a list of items which are formatted as strings, the time the order was created which has a date-time format, the status of the order which is formatted as a string, and a user who placed the order which is formatted according to the definition of another one of the data components 400.

Referring again to FIG. 4, the message components 404 define the format of messages used by the component application program 302 to communicate with external systems such as the web service. For example, one of the message components 404 may describe such as but not limited to a message for placing an order which includes the unique identifier for the order, the status of the order, and notes associated with the order.

Referring again to FIG. 4, the presentation components 402 define the appearance and behavior of the component application program 302 as it displayed by the user interface 202. The presentation components 402 can specify GUI screens and controls, and actions to be executed when the user interacts with the component application 302 using the user interface 202. For example, the presentation components 402 may define screens, labels, edit boxes, buttons and menus, and actions to be taken when the user types in an edit box or pushes a button. The majority of Web Service consumers use a visual presentation of Web Service operation results, and therefore provide the runtime environment on their devices 100 capable of displaying user interface screens.

Referring to FIGS. 1 and 4, it is recognized that in the above described client component application program 302 definitions hosting model, the presentation components 402 may vary depending on the client platform and environment of the device 100. For example, in some cases Web Service consumers do not require a visual presentation. The application definition of the components 400, 402, 404, 406 of the component application program 302 can be hosted in a Web Service registry as a bundle of platform-neutral data 400, message 404, workflow 406 component descriptors with a set of platform-specific presentation component 402 descriptors for various predefined client runtimes 206 (see FIG. 2). When the discovery or deployment request message 105 is issued the client type should be specified as a part of this request message 105. In order not to duplicate data, message, and workflow metadata while packaging component application programs 302 for different client platforms of the communication devices 100, application definitions can be hosted on the application server 110 (for example) as a bundle of platform-neutral component definitions linked with different sets of presentation components 402. When a user makes a discovery or download request message 105, the client runtime type of the communication devices 100,116 is validated and the proper bundle is constructed for delivery by the web server 106 to the device 100 over the network 102, 104. For those Web Service consumers, the client application programs 302 would contain presentation components 402 linked with the data 400 and message 404 components through the workflow components 406.

Referring again to FIG. 4, the workflow components 406 of the component application program 302 define processing that occurs when an action is to be performed, such as an action specified by a presentation component 402 as described above, or an action to be performed when messages 105 (see FIG. 1) arrive from the system 10. Presentation, workflow and message processing are defined by the workflow components 406. The workflow components 406 are written as a series of instructions in a programming language or a scripting language, such as but not limited to ECMAScript, and can be compiled into native code and executed by the runtime environment 206, as described above. An example of the workflow components 406 may be to assign values to data, manipulate screens, or send the message 105. As with presentation components, multiple workflow definitions can be created to support capabilities and features that vary among devices 100. The appropriate workflow definition can be determined and sent at the time of downloading and provisioning of the application program 302.

ECMA (European Computer Manufacturers Association) Script is a standard script language, wherein scripts can be referred to as a sequence of instructions that is interpreted or carried out by another program rather than by the computer processor. Some other example of script languages are Perl, Rexx, VBScript, JavaScript, and Tcl/Tk. The scripting languages, in general, are instructional languages that are used to manipulate, customize, and automate the facilities of an existing system, such as the devices 100. In such systems, useful functionality is already available through the user interface 202 (see FIG. 2), and the scripting language is a mechanism for exposing that functionality to program control. In this way, the device 100 is said to provide a host runtime environment of objects and facilities which completes the capabilities of the scripting language.

Specifically, EMCAScript is an object-oriented programming language for performing computations and manipulating computational objects within the host runtime environment. ECMAScript can be used as a Web scripting language, providing a mechanism to perform server 106,110 computation as part of the Web-based client-server architecture of the system 10 (see FIG. 1). ECMAScript provides core scripting capabilities for a variety of host runtime environments, and therefore the core scripting language can be considered platform neutral for a number of particular host runtime environments. The runtime environment 206 (see FIG. 2) can provide the ECMAScript host runtime environment for client-side computation of the communication devices 100, such as but not limited to; objects that represent windows, menus, pop-ups, dialog boxes, text areas, anchors, frames, history, cookies, and input/output. Further, the host runtime environment of the runtime environment 206 provides a means to attach scripting code to events such as but not limited to change of focus, page and image loading, unloading, error, and abort, selection, form submission, and mouse actions. In implementations using ECMA scripting, the code appears within the workflow components 406, combines user interface elements and fixed and computed text and images, and is reactive to user interaction on the user interface 202. The web server 106 (see FIG. 1) provides a different host environment for server-side computation including objects representing requests, clients, and files, and mechanisms to lock and share data. By using the client side and server side scripting together, it is possible to distribute computation between the client communication devices 100 and the servers 106,110 while providing a customized user interface 202 for the Web-based component application programs 302.

ECMAScript also defines a set of built-in operators which may not be, strictly speaking, functions or methods. ECMAScript operators include such as but not limited to various unary operations, multiplicative operators, additive operators, bitwise shift operators, relational operators, equality operators, binary bitwise operators, binary logical operators, assignment operators, and the comma operator. ECMAScript syntax resembles Java syntax, however, ECMAScript syntax is relaxed to enable it to serve as an easy-to-use scripting language for developers. For example, a variable in ECMAScript is not required to have its type declared nor are types associated with properties, and defined functions are not required to have their declarations appear textually before calls to them. It is recognized that in a class-based object-oriented programming language, in general, state is carried by instances, methods are carried by classes, and inheritance is only of structure and behavior. In ECMAScript, the state and methods are carried by objects, and structure, behavior, and state are all inherited.

Component Application Program Example

Accordingly, referring to FIG. 4, the client application programs 302 can be defined as a set of platform-neutral component definitions, namely for data 400 and message 404 components, and presentation components 402 using XML (or any other suitable structured definition language). The workflow components 406 can be defined using ECMAScript (or any other suitable platform-neutral scripting language). The client runtime environment 206 (see FIG. 2) can generate component templates based on meta-definitions when the components 400, 402, 404, 406 of the component application program 302 are provisioned on the communication device 100. With a large variety of terminal runtime environments 206, the cross-platform standards such as XML or ECMAScript can be used to define application component metadata instead of pre-building the component application programs 302. This delayed binding can allow generic application definitions of the component application programs 302 to be run on a wide variety of terminal system environments 206, represented by various different communication devices 100.

The following example shows how a Web Services client application program 302 could be expressed using a structured definition language, such as but not limited to XML, and a platform neutral scripting/programming language, such as but not limited to ECMAScript, with defined components conforming with the following Document Type Definition (DTD):

```
<!ELEMENT wcApp (desc?, iconUrl?, res*, wcData*,
wcMsg*, style*, wcScr*, wcFlow)>
<!ATTLIST wcApp
  name CDATA #REQUIRED
  title CDATA #IMPLIED
  vendor CDATA #IMPLIED
  version CDATA #IMPLIED
  transportKey CDATA #IMPLIED
  installNotifURL CDATA #IMPLIED
  registerURL CDATA #IMPLIED
>
<!ELEMENT desc (#PCDATA)>
<!ELEMENT iconUrl (#PCDATA)>
<!ELEMENT res (#PCDATA)>
<!ATTLIST res
  name CDATA #REQUIRED
  url CDATA #REQUIRED
  type (xml | image | sound | any) #REQUIRED
  deferred (true | false) “false”
>
Example Data Component 400
<!ELEMENT wcData (dfield+)>
<!ATTLIST wcData
  name CDATA #REQUIRED
  persisted (true | false) “true”
>
<!ELEMENT dfield (#PCDATA)>
<!ATTLIST dfield
  name CDATA #REQUIRED
  type (String | Number | Boolean | Date | Any) “Any”
  array (true | false) “false”
  cmp (true | false) “false”
  cmpName CDATA #IMPLIED
  key (0 | 1 | 2) “0”
>
Example Message Component 404
<!ELEMENT wcMsg (mfield*)>
<!ATTLIST wcMsg
  name CDATA #REQUIRED
  mapping CDATA #IMPLIED
>
<!ATTLIST wcMsg
  pblock CDATA #IMPLIED
>
<!ELEMENT mfield (#PCDATA)>
<!ATTLIST mfield
  name CDATA #REQUIRED
  type (String | Number | Boolean | Date | Array | XML) #IMPLIED
  mapping CDATA #IMPLIED
>
Example Presentation Components 402
<!ELEMENT wcScr (layout?, menu?, refresh?, event?)>
<!ATTLIST wcScr
  name CDATA #REQUIRED
  title CDATA #IMPLIED
  main (true | false) “false”
  dialog (true | false) “false”
  param CDATA #IMPLIED
>
<!ELEMENT style (font?)>
<!ATTLIST style
  name CDATA #REQUIRED
  bgColor CDATA #IMPLIED
>
<!ELEMENT font EMPTY>
<!ATTLIST font
  name CDATA #REQUIRED
  color CDATA #IMPLIED
  size CDATA #IMPLIED
  bold (true | false) “false”
  italic (true | false) “false”
  underline (true | false) “false”
>
<!ELEMENT refresh (msg+)>
<!ELEMENT msg (#PCDATA)>
<!ELEMENT layout (layout*, label*, separator*, edit*, image*, choice*,
button*, textarea*)>
<!ATTLIST layout
  type (grid | flow | border | vertical) #REQUIRED
  param CDATA #IMPLIED
  placement CDATA #IMPLIED
  style CDATA #IMPLIED
>
<!ELEMENT menu (item*)>
<!ELEMENT item (action, condition?)>
<!ATTLIST item
  name CDATA #REQUIRED
  label CDATA #REQUIRED
  shortcut CDATA #IMPLIED
>
<!ELEMENT action EMPTY>
<!ATTLIST action
  screen CDATA #IMPLIED
  pblock CDATA #IMPLIED
  param CDATA #IMPLIED
  acceptChanges (true | false) “true”
>
<!ELEMENT condition EMPTY>
<!ATTLIST condition
  pblock CDATA #REQUIRED
  param CDATA #IMPLIED
  result (true | false) “true”
>
<!ELEMENT event EMPTY>
<!ATTLIST event
  type (onInit | onClick | onChange | onFocusOut) “onInit”
  pblock CDATA #IMPLIED
  screen CDATA #IMPLIED
  param CDATA #IMPLIED
>
<!ELEMENT separator EMPTY>
<!ELEMENT label (condition?, event?)>
<!ATTLIST label
  name CDATA #REQUIRED
  value CDATA #REQUIRED
  placement CDATA #IMPLIED
  style CDATA #IMPLIED
>
<!ELEMENT edit (condition?, event?)>
<!ATTLIST edit
  name CDATA #REQUIRED
  value CDATA #IMPLIED
  mapping CDATA #IMPLIED
  type (char | number | date | pwd | phone | email) “char”
  readOnly (true | false) “false”
  placement CDATA #IMPLIED
  style CDATA #IMPLIED
>
<!ELEMENT textarea (condition?, event?)>
<!ATTLIST textarea
  name CDATA #REQUIRED
  value CDATA #IMPLIED
  mapping CDATA #IMPLIED
  readOnly (true | false) “false”
  placement CDATA #IMPLIED
  style CDATA #IMPLIED
>
<!ELEMENT image (condition?, event?)>
<!ATTLIST image
  name CDATA #REQUIRED
  resName CDATA #REQUIRED
  placement CDATA #IMPLIED
>
<!ELEMENT choice (condition?, event?, entry*)>
<!ATTLIST choice
  name CDATA #REQUIRED
  value CDATA #IMPLIED
  mapping CDATA #IMPLIED
  type (singleList | multiList | dropdown | checkbox | radio) “singleList”
  readOnly (true | false) “false”
  placement CDATA #IMPLIED
  style CDATA #IMPLIED
>
<!ELEMENT entry (#PCDATA)>
<!ELEMENT button (condition?, event?)>
<!ATTLIST button
  name CDATA #REQUIRED
  label CDATA #REQUIRED
  image (true | false) “false”
  placement CDATA #IMPLIED
  style CDATA #IMPLIED
>
Example Workflow Component 406
<!ELEMENT wcFlow (pblock+)>
<!ELEMENT pblock (#PCDATA)>
<!ATTLIST pblock
  id CDATA #REQUIRED
  param CDATA #IMPLIED
>
```

As given above, the XML elements define the example component application 302 including a wcApp element, a wcData element, a wcMsg element, a wcSrc element, and a wcFlow element. Referring to FIG. 3, the wcApp element is a top-level element which defines the component application program 302. The wcData element defines the example data component 400, which is comprised of a group of named, typed fields. The wcMsg element defines the example message component 404, which similarly defines a group of named, typed fields. The wcSrc element defines the example presentation component 402. The example presentation component 402 is a label, a separator, an image, a button, an edit field, a text area, a single-selection list, a multi-selection list, a drop-list, a checkbox, a radio button, or a screen containing a group of other presentation components 402.

Referring to the above example component application program 302 and FIG. 3, the wcFlow element defines the example workflow components 406. The pblock attributes of the XML elements specify a pblock element nested in the wcFlow element. Each pblock element comprises script which defines part of the workflow of the component application program 302. The script is written in ECMAScript.

In order to define the behavior of the component application 302, the workflow components 406 use ECMAScript to reference and manipulate the data components 400, the presentation components 402, and the message components 404. Workflow components 406 can also reference external object types, which allow actions to be performed on the components defined in the component application 302. For example, a wcMsg type allows a message defined by a message component 404 to be evaluated to determine whether mandatory fields have been supplied, and to be sent to an external system such as the web service of the server 106. A wcData type allows the size of collections of data entities defined by data components 400 to be determined, and allows data entities to be deleted. A wcScr type allows a presentation component 402 to be displayed to the user. Similarly, a special dialog external object allows a message to be displayed to the user on the user interface 202 (see FIG. 2).

Example Component Application Program 302 with Interface

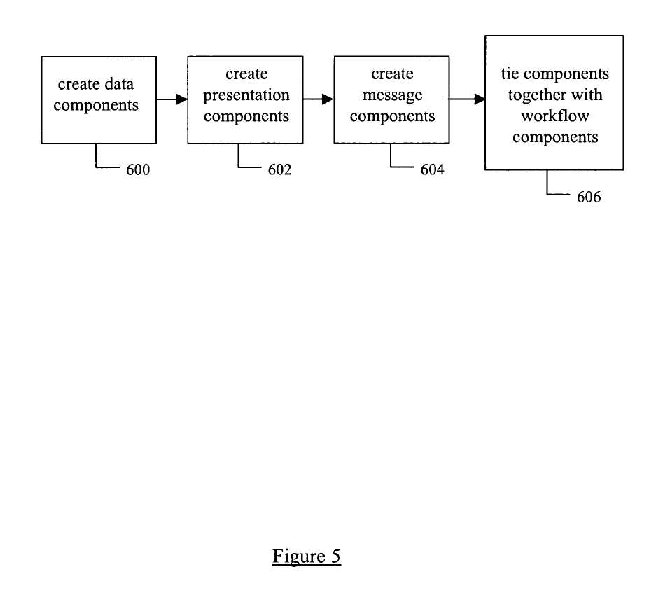

Referring to FIGS. 1 and 5, a block diagram illustrating a further example component application program 302 is shown. The presentation components 402 included in the example component application 302 define a login screen 500, a specials screen 502, a delivery information screen 504, an order list screen 508, and an order status screen 506. These screens would be presented on the user interface 202 (see FIG. 2) of the communication devices 100. The example component application 302 allows a user to view a pizza menu, to order a pizza for delivery, and to view details of past orders. The user is first presented with the login screen 500 on the user interface 202. The user provides a user name and password, and then pushes a login button 501. The workflow component 406 checks the user name and password against a user profile which is provided by the web service of the server 106 through messages 105. If the user is successfully logged in, then the specials screen 502 is displayed. From the specials screen 502, the user can select menu items to place an order or to view the status of orders, which determines whether the delivery information screen 504 is displayed, or if the order list screen 508 is displayed. The delivery information screen 504 allows the user to specify details of an order. The information provided by the user is stored using the data component 400 which describes an order.

The user then selects a menu item to send the order, which triggers the workflow component 406 to send the message 105 defined by the corresponding message component 404 containing order information to the web service on the server 106. The order list screen 508 lists past orders, and allows a user to select a menu item to view details of one or more of the listed orders. After sending an order or selecting the menu item to view order details, the order status screen 506 is displayed, based on response messages 105 received by the device 100 and subsequently processed by the relevant message 404, workflow 406, presentation 402, and data 400 components. The order status screen 506 contains information describing orders that the user has placed, and a menu item which, when selected, causes the specials screen 502 to be displayed. The message components 404 relay the required data for the input and output of the messages 105. The corresponding data components 400 coordinate the storage of the data in the memory module 210 (see FIG. 2) of the device 100 for subsequent presentation on the user interface by the presentation components 402. The workflow components 406 coordinate the transfer of data between the data 400, presentation 402, and message 404 components.

The example component application program 302 displayed in FIG. 5 is represented in XML and mEScript as follows, including data components 400 as “wcData”, message components 404 as “wcMsg”, presentation components 402 as “wcScr” and workflow components 406 as “wcFlow” for processing the other components 400, 402, 404:

```
<!DOCTYPE wcApp SYSTEM “wcApp.dtd”>
<wcApp name=“WirelessPizza” title=“Wireless Pizza” vendor=“ARG” version=“0.9”>
  <desc> Order pizza from your wireless device. </desc>
  <iconUrl>http://www.example.com/wirelessPizzaIcon.png</iconUrl>
  <wcData name=“User”>
    <dfield name=“name” type=“String” key=“1”/>
    <dfield name=“passwordHash” type=“String”/>
    <dfield name=“street” type=“String”/>
    <dfield name=“city” type=“String”/>
    <dfield name=“postal” type=“String”/>
    <dfield name=“phone” type=“String”/>
  </wcData>
  <wcData name=“OrderStatus”>
    <dfield name=“confNumber” type=“Number” key=“1”/>
    <dfield name=“status” type=“String”/>
    <dfield name=“datetime” type=“Date”/>
  </wcData>
  <wcData name=“Order”>
    <dfield name=“orderId” type=“Number” key=“1”/>
    <dfield name=“special” type=“String”/>
    <dfield name=“user” cmp=“true” cmpName=“User”/>
    <dfield name=“datetime” type=“Date”/>
    <dfield name=“orderStatus” cmp=“true” cmpName=“OrderStatus”/>
  </wcData>
  <wcData name=“Special”>
    <dfield name=“desc” key=“1” type=“String”/>
    <dfield name=“price” type=“Number”/>
  </wcData>
  <wcMsg name=“inAddSpecial” mapping=“Special”>
  </wcMsg>
  <wcMsg name=“inRemoveSpecial” pblock=“mhRemoveSpecial”>
    <mfield name=“desc” mapping=“Special.desc”/>
  </wcMsg>
  <wcMsg name=“inOrderStatus”>
    <mfield name=“orderId” mapping=“Order.orderId”/>
    <mfield name=“status” mapping=“Order.orderStatus”/>
  </wcMsg>
  <wcMsg name=“inUserInfo” mapping=“User”>
  </wcMsg>
  <wcMsg name=“outOrder”>
    <mfield name=“special” mapping=“Order.special”/>
    <mfield name=“user” mapping=“Order.user”/>
    <mfield name=“datetime” mapping=“Order.datetime”/>
  </wcMsg>
  <wcScr name=“scrSpecials” title=“Specials” main=“true”>
    <layout type=“flow”>
      <choice name=“slSpecials” value=“Special [symbol] .desc + ‘− $’ + Special [symbol] .price”
type=“singleList”/>
    </layout>
    <menu>
      <item name=“login” label=“Login”>
        <action screen=“scrLogin”/>
        <condition pblock=“chLoggedin” result=“false”/>
      </item>
      <item name=“order” label=“Order”>
        <action screen=“scrDelivery” param=“Application.authenticatedUser”/>
        <condition pblock=“chLoggedin”/>
      </item>
      <item name=“viewOrderStatus” label=“View Orders Status”>
        <action screen=“scrOrdersList”/>
        <condition pblock=“chLoggedin”/>
      </item>
    </menu>
  </wcScr>
  <wcScr name=“scrLogin” dialog=“true”>
    <layout type=“vertical”>
      <layout type=“flow”>
        <label name=“lblUserName” value=“User Name:”/>
        <edit name=“edUserName” type=“char”/>
      </layout>
      <layout type=“flow”>
        <label name=“lblPassword” value=“Password:”/>
        <edit name=“edPassword” type=“pwd”/>
      </layout>
      <button name=“btnLogin” label=“Login”>
        <event type=“onClick” pblock=“ahLogin” param=“edUserName.value”/>
      </button>
    </layout>
  </wcScr>
  <wcScr name=“scrDelivery” title=“Please provide delivery information” param=“User”>
    <layout type=“vertical”>
      <layout type=“flow”>
        <label name=“lblStreet” value=“Street:”/>
        <edit name=“street” mapping=“User.street” type=“char”/>
      </layout>
      <layout type=“flow”>
        <label name=“lblCity” value=“City:”/>
        <edit name=“city” mapping=“User.city” type=“char”/>
      </layout>
      <layout type=“flow”>
        <label name=“lblPostalCode” value=“Postal code:”/>
        <edit name=“postalCode” mapping=“User.postal” type=“char”/>
      </layout>
      <layout type=“flow”>
        <label name=“lblPhone” value=“Telephone:”/>
        <edit name=“phone” mapping=“User.phone” type=“phone”/>
      </layout>
      <layout type=“flow”>
        <label name=“lblDate” value=“Date of delivery:”/>
        <edit name=“date” type=“date”/>
      </layout>
    </layout>
    <menu>
      <item name=“sendOrder” label=“Send Order”>
        <action pblock=“ahSendOrder” param=“User”/>
      </item>
    </menu>
  </wcScr>
  <wcScr name=“scrOrderStatus” title=“Order status” param=“Order [symbol] ”>
    <layout type=“vertical” param=“%”>
      <layout type=“flow”>
        <label name=“lblSpecialr” value=“Special:”/>
        <label name=“lblSpecialMapped” value=“@Order [symbol] .special”/>
      </layout>
      <layout type=“flow”>
        <label name=“lblConfNumber” value=“Confirmation number:”/>
        <label name=“lblConfNumberMapped”
value=“@Order [symbol] .orderStatus.confNumber”/>
      </layout>
      <layout type=“flow”>
        <label name=“lblStatus” value=“Status:”/>
        <label name=“lblStatusMapped” value=“@Order [symbol] .orderStatus.status”/>
      </layout>
      <layout type=“flow”>
        <label name=“lblConfDate” value=“Date of last status update:”/>
        <label name=“lblConfDateMapped”
value=“@Order [symbol] .orderStatus.datetime”/>
      </layout>
      <separator/>
    </layout>
    <menu>
      <item name=“continue” label=“Continue”>
        <action screen=“scrSpecials”/>
      </item>
    </menu>
    <refresh>
      <msg> inOrderStatus </msg>
    </refresh>
  </wcScr>
  <wcScr name=“scrOrdersList” title=“Previous Orders”>
    <layout type=“vertical”>
      <label name=“lblInstructions” value=“Select one or more order:”/>
      <choice name=“mlOrderList” value=“@Order [symbol] .datetime + ‘−’ + @Order [symbol] .special”
mapping=“Order [symbol] ” type=“multiList”/>
    </layout>
    <menu>
      <item name=“viewOrder” label=“View Order”>
        <action screen=“scrOrderStatus” param=“mlOrderList.selected”/>
      </item>
    </menu>
  </wcScr>
  <wcFlow>
    <pblock id=“chLoggedin”>
      return Application.authenticatedUser != null;
    </pblock>
    <pblock id=“ahLogin” param=“User.name”>
      if(User.passwordHash == Util.md5(scrLogin.edPassword) ) {
        Application.authenticatedUser = User;
        scrLogin.back( );
      } else {
      Dialog.display(“Invalid login!”);
      }
    </pblock>
    <pblock id=“ahSendOrder” param=“User”>
      Order.orderId = Util.guid( );
      Order.special = scrSpecials.slSpecials.selected;
      Order.user = User;
      Order.datetime = scrDelivery.date;
      OrderStatus.confNumber = Util.guid( );
      OrderStatus.status = “Sent. Pending response.”;
      OrderStatus.date = Util.currentDate( );
      Order.orderStatus = OrderStatus;
      outOrder.send( );
      scrOrderStatus.display(Order);
    </pblock>
    <pblock id=“mhRemoveSpecial” param=“inRemoveSpecial”>
      Special.desc = inRemoveSpecial.desc;
      Special.delete( );
    </pblock>
  </wcFlow>
</wcApp>
```

FIG. 5 is a flowchart illustrating a method of building the wireless component application 302 for subsequent communication over the network 102, 104 to the device 100. Referring as well to FIG. 3, the method begins with step 600 of creating the data components 400 for defining data entities such as users and orders. The method continues with step 602 of creating presentation components 402 for defining user-interface elements such as screens, buttons, menus and images. The method continues with step 604 of creating message components 402 for defining messages formats which are sent to external systems such as web services on the server 106 (see FIG. 1). The components 400, 402, 404 are expressed in the structured definition language such as but not limited to one based on XML. The method concludes with step 606 of tying together the data 400, presentation 402 and message 404 components with workflow components 406 in order to define the behavior of the application 302. The workflow components 406 are written as a series of instructions, such as but not limited to ECMAScript, which is described above. The method of building a wireless component application 302 may include fewer or more steps that those shown in FIG. 5.

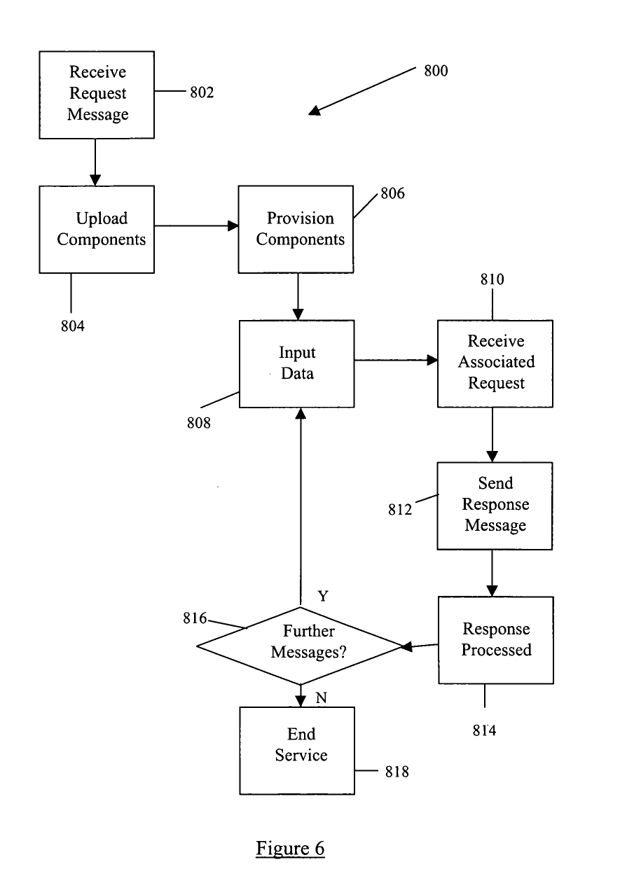

Referring to FIGS. 1 and 6, operation 800 of the interaction between the devices 100 and the web service of the web server 106 is shown. The web service receives 802 the request message 105 requesting that the device 100 begin communications with the web service. The web service uploads 804 the required components 400, 402, 404, 406 (if any) of the component application 302 to the device 100, in order to support subsequent information exchange between the web service and the device 100. The device receives the transmitted component application 302 and proceeds to provision 806 the components 400, 402, 404, 406 by the runtime environment 206 (see FIG. 3), in order to configure the device as a web client of the web service, by producing an executable version of the component application 302. The user of the device 100 inputs 808 data into the user interface 202 (see FIG. 2) of the device 100 for subsequent sending 810 to the web service as a request message 105 for receiving web service operations. The web service processes the request message 105 and sends 812 the appropriate response message 105 including data for subsequent output on the user interface 202. The device 100 receives 814 the message 105 containing the data and the executable version of the component application 302 outputs the data appropriately on the user interface 202. Further data exchange 816 is performed between the device 100 and the web service as per above, or the exchange is terminated 818 and the executable version of the component application 302 is either saved in the memory 210 (see FIG. 2) or is deleted from the runtime environment 206 as desired.

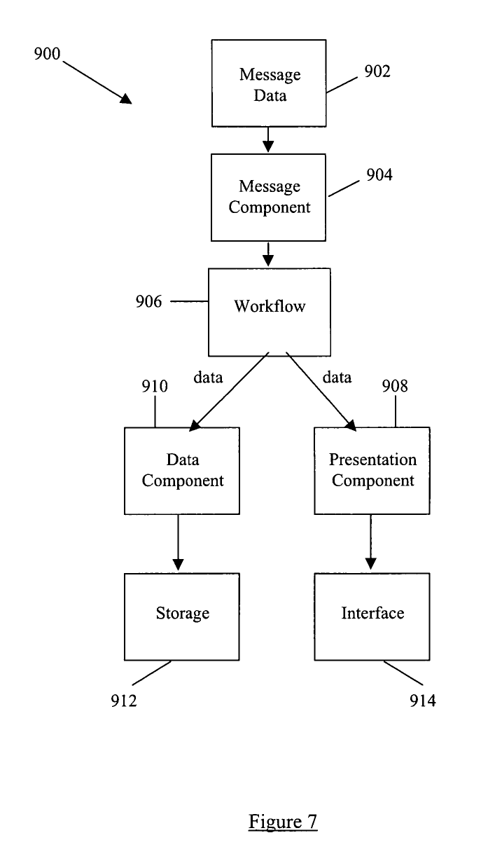

Referring to FIGS. 1, 3 and 7, for example, operation 900 shows when the device 100 receives 902 the response message 105 containing message data, the appropriate workflow component 406 interprets 904 the data content of the message 105 according to the appropriate message component 404. The workflow component 406 then processes 906 the data content and inserts 910 the data into the corresponding data component 400 for subsequent storage 912 in the memory module 210 (see FIG. 2). Further, if needed, the workflow component 406 also inserts 908 the data into the appropriate presentation component 402 for subsequent display 914 on the user interface 202 (see FIG. 2).

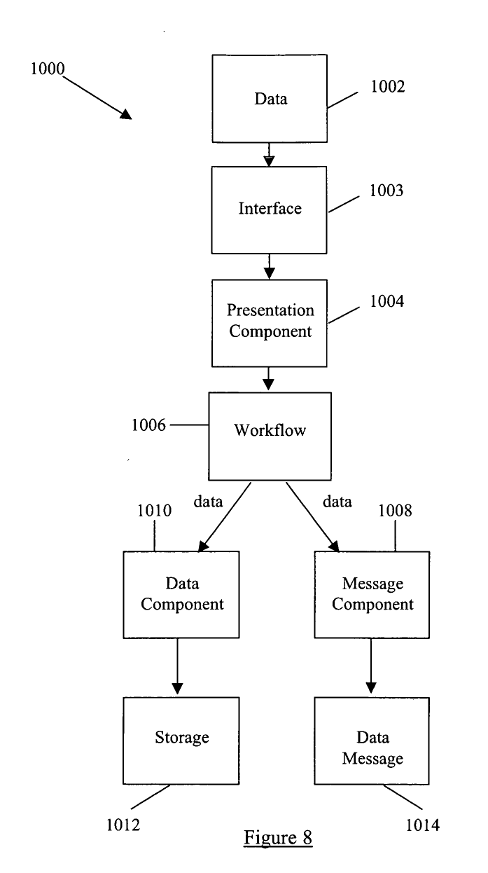

Referring to FIGS. 1, 3 and 8 operation 1000 shows data input 1002 for an action, such as pushing a button or selecting a menu item, which the user performed 1003 on a user-interface element through the user interface 202 (see FIG. 2). The relevant workflow component 406 interprets 1004 the input data according to the appropriate presentation component 404 and creates 1006 data entities which are defined by the appropriate data components 400. The workflow component 406 then populates 1010 the data components 400 with the input data provided by the user for subsequent storage 1012 in the memory module 210 (see FIG. 2). Further, the workflow component 406 also inserts 1008 the input data into the appropriate message component 404 for subsequent sending 1014 of the input data as data entities to the web service in the message 105, as defined by the message component 404.

It is recognized that component applications 302 which are created using the methods described above can require less time to create than hard coded applications, since the component applications 302 do not use full programming languages, but rather use standards-based technologies such as XML and ECMAScript, which are comparatively simple and easy to learn. The methods can result in component applications 302 in which the user-interface 202 and the definition of the data are decoupled. This decoupling allows for modification of any component 400, 402, 404, 406 in the component application 302 without affecting and requiring substantial changes to other components 400, 402, 404, 406 in the application 302, and thus can facilitate maintenance of the component applications 302, including modification and updating of the component applications 302 on the device 100.

FIG. 9 is a block diagram of a dual-mode mobile communication device 710, which is a further example of the device 100 of FIGS. 1 and 6. The dual-mode mobile communication device 710 includes a transceiver 711, a microprocessor 738, a display 722, Flash memory 724, RAM memory 726, auxiliary input/output (I/O) devices 728, a serial port 730, a keyboard 732, a speaker 734, a microphone 736, a short-range wireless communications sub-system 740, and may also include other device sub-systems 742. The transceiver 711 preferably includes transmit and receive antennas 716, 718, a receiver 712, a transmitter 714, one or more local oscillators 713, and a digital signal processor 720. Within the Flash memory 724, the dual-mode mobile communication device 710 preferably includes a plurality of software modules 724A-724N that can be executed by the microprocessor 738 (and/or the DSP 720), including a voice communication module 724A, a data communication module 724B, and a plurality of other operational modules 724N for carrying out a plurality of other functions.

The dual-mode mobile communication device 710 is preferably a two-way communication device having voice and data communication capabilities. Thus, for example, the dual-mode mobile communication device 710 may communicate over a voice network, such as any of the analog or digital cellular networks, and may also communicate over a data network. The voice and data networks are depicted in FIG. 9 by the communication tower 719. These voice and data networks may be separate communication networks using separate infrastructure, such as base stations, network controllers, etc., or they may be integrated into a single wireless network.

The communication subsystem 711 is used to communicate with the voice and data network 719, and includes the receiver 712, the transmitter 714, the one or more local oscillators 713 and may also include the DSP 720. The DSP 720 is used to send and receive signals to and from the transmitter 714 and receiver 712, and is also utilized to receive control information from the transmitter 714 and to provide control information to the receiver 712. If the voice and data communications occur at a single frequency, or closely-spaced set of frequencies, then a single local oscillator 713 may be used in conjunction with the transmitter 714 and receiver 712. Alternatively, if different frequencies are utilized for voice communications versus data communications, then a plurality of local oscillators 713 can be used to generate a plurality of frequencies corresponding to the voice and data networks 719. Although two antennas 716, 718 are depicted in FIG. 9, the dual-mode mobile communication device 710 could be used with a single antenna structure. Information, which includes both voice and data information, is communicated to and from the communication module 711 via a link between the DSP 720 and the microprocessor 738. The detailed design of the communication subsystem 711, such as frequency band, component selection, power level, etc., is dependent upon the communication network 719 in which the dual-mode mobile communication device 710 is intended to operate. For example, a dual-mode mobile communication device 710 intended to operate in a North American market may include a communication subsystem 711 designed to operate with the Mobitex™ or DataTAC™ mobile data communication networks and also designed to operated with any of a variety of voice communication networks, such as AMPS, TDMA, CDMA, PCS, etc., whereas a device 710 intended for use in Europe may be configured to operate with the General Packet Radio Service (GPRS) data communication network and the GSM voice communication network. Other types of data and voice networks, both separate and integrated, may also be utilized with the dual-mode mobile communication device 710.

Depending upon the type of network or networks 719, the access requirements for the dual-mode mobile communication device 710 may also vary. For example, in the Mobitex and DataTAC data networks, mobile devices are registered on the network using a unique identification number associated with each device. In GPRS data networks, however, network access is associated with a subscriber or user of a mobile device. A GPRS device typically requires a subscriber identity module (“SIM”), which is required in order to operate a dual-mode mobile communication device on a GPRS network. Local or non-network communication functions (if any) may be operable, without the SIM, but a dual-mode mobile communication device will be unable to carry out any functions involving communications over the data network 719, other than any legally required operations, such as 911 emergency calling.

After any required network registration or activation procedures have been completed, the dual-mode mobile communication device 710 may then send and receive communication signals, including both voice and data signals, over the network 719 (or networks). Signals received by the antenna 716 from the communication network 719 are routed to the receiver 712, which provides for signal amplification, frequency down conversion, filtering, channel selection, etc., and may also provide analog to digital conversion. Analog to digital conversion of the received signal allows more complex communication functions, such as digital demodulation and decoding to be performed using the DSP 720. In a similar manner, signals to be transmitted to the network 719 are processed, including modulation and encoding, for example, by the DSP 720 and are then provided to the transmitter 714 for digital to analog conversion, frequency up conversion, filtering, amplification and transmission to the communication network 719 (or networks) via the antenna 718. Although a single transceiver 711 is shown in FIG. 9 for both voice and data communications, it is possible that the dual-mode mobile communication device 710 may include two distinct transceivers, a first transceiver for transmitting and receiving voice signals, and a second transceiver for transmitting and receiving data signals.

In addition to processing the communication signals, the DSP 720 also provides for receiver and transmitter control. For example, the gain levels applied to communication signals in the receiver 712 and transmitter 714 may be adaptively controlled through automatic gain control algorithms implemented in the DSP 720. Other transceiver control algorithms could also be implemented in the DSP 720 in order to provide more sophisticated control of the transceiver 711.

The microprocessor 738 preferably manages and controls the overall operation of the dual-mode mobile communication device 710. Many types of microprocessors or microcontrollers could be used here, or, alternatively, a single DSP 720 could be used to carry out the functions of the microprocessor 738. Low-level communication functions, including at least data and voice communications, are performed through the DSP 720 in the transceiver 711. Other, high-level communication applications, such as a voice communication application 724A, and a data communication application 724B may be stored in the Flash memory 724 for execution by the microprocessor 738. For example, the voice communication module 724A may provide a high-level user interface operable to transmit and receive voice calls between the dual-mode mobile communication device 710 and a plurality of other voice devices via the network 719. Similarly, the data communication module 724B may provide a high-level user interface operable for sending and receiving data, such as e-mail messages, files, organizer information, short text messages, etc., between the dual-mode mobile communication device 710 and a plurality of other data devices via the network 719. In the dual-mode mobile communication device 710, a component framework 206 as described above may also be implemented as a software module or application, or incorporated into one of the software modules 724A-724N.

The microprocessor 738 also interacts with other dual-mode mobile communication device subsystems, such as the display 722, Flash memory 724, random access memory (RAM) 726, auxiliary input/output (I/O) subsystems 728, serial port 730, keyboard 732, speaker 734, microphone 736, a short-range communications subsystem 740 and any other dual-mode mobile communication device subsystems generally designated as 742.

Some of the subsystems shown in FIG. 9 perform communication-related functions, whereas other subsystems may provide resident or on-device functions. Notably, some subsystems, such as keyboard 732 and display 722 may be used for both communication-related functions, such as entering a text message for transmission over a data communication network, and device-resident functions such as a calculator or task list or other PDA type functions.

Operating system software used by the microprocessor 738 is preferably stored in a persistent store such as Flash memory 724. In addition to the operating system, which controls all of the low-level functions of the dual-mode mobile communication device 710, the Flash memory 724 may include a plurality of high-level software application programs, or modules, such as a voice communication module 724A, a data communication module 724B, an organizer module (not shown), or any other type of software module 724N. The Flash memory 724 also may include a file system for storing data. These modules are executed by the microprocessor 738 and provide a high-level interface between a user of the dual-mode mobile communication device and the mobile device. This interface typically includes a graphical component provided through the display 722, and an input/output component provided through the auxiliary I/O 728, keyboard 732, speaker 734, and microphone 736. The operating system, specific dual-mode mobile communication device software applications or modules, or parts thereof, may be temporarily loaded into a volatile store, such as RAM 726 for faster operation. Moreover, received communication signals may also be temporarily stored to RAM 726, before permanently writing them to a file system located in the persistent store 724.

An exemplary application module 724N that may be loaded onto the dual-mode mobile communication device 710 is a personal information manager (PIM) application providing PDA functionality, such as calendar events, appointments, and task items. This module 724N may also interact with the voice communication module 724A for managing phone calls, voice mails, etc., and may also interact with the data communication module for managing e-mail communications and other data transmissions. Alternatively, all of the functionality of the voice communication module 724A and the data communication module 724B may be integrated into the PIM module.

The Flash memory 724 preferably provides a file system to facilitate storage of PIM data items on the dual-mode mobile communication device 710. The PIM application preferably includes the ability to send and receive data items, either by itself, or in conjunction with the voice and data communication modules 724A, 724B, via the wireless network 719. The PIM data items are preferably seamlessly integrated, synchronized and updated, via the wireless network 719, with a corresponding set of data items stored or associated with a host computer system, thereby creating a mirrored system for data items associated with a particular user.

The dual-mode mobile communication device 710 may also be manually synchronized with a host system by placing the dual-mode mobile communication device 710 in an interface cradle, which couples the serial port 730 of the dual-mode mobile communication device 710 to the serial port of the host system. The serial port 730 may also be used to enable a user to set preferences through an external device or software application, or to download other application modules 724N for installation. This wired download path may be used to load an encryption key onto the dual-mode mobile communication device 710, which is a more secure method than exchanging encryption information via the wireless network 719.

Additional application modules 724N may be loaded onto the dual-mode mobile communication device 710 through the network 719, through an auxiliary I/O subsystem 728, through the serial port 730, through the short-range communications subsystem 740, or through any other suitable subsystem 742, and installed by a user in the Flash memory 724 or RAM 726. Such flexibility in application installation increases the functionality of the dual-mode mobile communication device 710 and may provide enhanced on-device functions, communication-related functions, or both. For example, secure communication applications may enable electronic commerce functions and other such financial transactions to be performed using the dual-mode mobile communication device 710.

When the dual-mode device 710 is operating in a data communication mode, a received signal, such as a text message or a web page download, will be processed by the transceiver 711 and provided to the microprocessor 738, which will preferably further process the received signal for output to the display 722, or, alternatively, to an auxiliary I/O device 728. A user of the dual-mode mobile communication device 710 may also compose data items, such as email messages, using the keyboard 732, which is preferably a complete alphanumeric keyboard laid out in the QWERTY style, although other styles of complete alphanumeric keyboards such as the known DVORAK style may also be used. User input to the dual-mode mobile communication device 710 is further enhanced with a plurality of auxiliary I/O devices 728, which may include a thumbwheel input device, a touchpad, a variety of switches, a rocker input switch, etc. The composed data items input by the user may then be transmitted over the communication network 719 via the transceiver 711.

When the dual-mode mobile communication device 710 is operating in a voice communication mode, the overall operation of the dual-mode mobile communication device 710 is substantially similar to the data mode, except that received signals are preferably be output to the speaker 734 and voice signals for transmission are generated by a microphone 736. Alternative voice or audio I/O subsystems, such as a voice message recording subsystem, may also be implemented on the dual-mode mobile communication device 710. Although voice or audio signal output is preferably accomplished primarily through the speaker 734, the display 722 may also be used to provide an indication of the identity of a calling party, the duration of a voice call, or other voice call related information. For example, the microprocessor 738, in conjunction with the voice communication module and the operating system software, may detect the caller identification information of an incoming voice call and display it on the display 722.

A short-range communications subsystem 740 is also included in the dual-mode mobile communication device 710. For example, the short-range communications subsystem 740 may include an infrared device and associated circuits and components, or a short-range wireless communication module such as a Bluetooth™ module or an 802.11 module to provide for communication with similarly-enabled systems and devices. Those skilled in the art will appreciate that “Bluetooth” and 802.11 refer to sets of specifications, available from the Institute of Electrical and Electronics Engineers (IEEE), relating to wireless personal area networks and wireless LANs, respectively.

Although the disclosure herein has been drawn to one or more exemplary systems and methods, many variations will be apparent to those knowledgeable in the field, and such variations are within the scope of the application. For example, although XML and a subset of ECMAScript are used in the examples provided, other languages and language variants may be used to define component applications. The proposed E4X standard scripting languages could be used in place of ECMAScript, for example. Further, other structured definition languages, than XML described above, can include such as but not limited to Resource Description Framework (RDF), XSLT, and XHTML. In addition, while the component applications are described as applications which are executed on mobile communication devices, component applications may also be executed on other computer systems, such as wireless configured personal computers.

We claim:

1. A method of interacting with a web service by a mobile communication device over a network, the method comprising the steps of:
receiving a request network message for establishing communication between the web service and the communication device;
sending in response to the request network message a component application program including a plurality of components, a first set of the components having descriptors expressed in a structured definition language and a second set of the components being expressed as a series of instructions, the components being configured for provisioning by a runtime environment of the communication device to produce an executable version of the component application program configuring the device as a web client of the web service;
wherein execution of the executable version provides for a subsequent exchange of information over the network between the web service and the communication device.

2. The method according to claim 1, wherein the runtime environment provides an interface for the executable version to the functionality of a processor and an associated operating system of an infrastructure of the communication device.

3. The method according to claim 2, wherein the runtime environment is configured for implementing capabilities selected from the group comprising; provide communications for sending a network message to the web service, provide data input by a user of the device for supplying data content for a network message associated with the web service, provide data presentation in response to a network message associated with the web service, provide data storage services for maintaining local client data in a memory of the device, and provide an execution environment for a scripting language for coordinating operation of the components in the executable version.

4. The method according to claim 2, wherein the runtime environment is configured as a portion of the operating system.

5. The method according to claim 2 further comprising the step of receiving a network message from the communication device, the network message configured based on the structured definition language corresponding to at least one of the first set of components.

6. The method according to claim 5 further comprising the step of processing the network message and sending a response network message containing message data formatted based on the structured definition language, the response network message configured for subsequent presentation of the message data on a user interface of the communication device.

7. The method according to claim 2 further comprising the step of including a data component in the first set of component definitions, the data component for defining information to describe data entities used by the program and a format for the information.

8. The method according to claim 7 further comprising the step of including a message component in the first set of component definitions, the message component for defining a format of messages used by the program to communicate over the network with the web service.

9. The method according to claim 8, wherein the data component definitions and message component definitions are platform neutral for accommodating a variety of different runtime environments.

10. The method according to claim 8 further comprising the step of including a presentation component in the first set of components, the presentation component for defining the appearance of the component application program as presented on a user interface of the device.

11. The method according to claim 10, wherein the presentation component is platform specific for various predefined runtime environments.

12. The method according to claim 10, wherein the structured definitions language is based on eXtensible Markup Language.

13. The method according to claim 10 further comprising the step of including a workflow component in the second set of components, the workflow component for defining processing that occurs when an action is to be performed as specified by one of the first set of components.

14. The method according to claim 13, wherein the series of instructions for the workflow component is expressed in an object oriented programming language.

15. The method according to claim 13, wherein the series of instructions for the workflow is expressed as a scripting language.

16. The method according to claim 15, wherein the scripting language is based on ECMA Script.

17. The method according to claim 13 further comprising the step of receiving a network message initiated by interaction of a user of the communication device with a user interface element, the network message containing data entities created by the workflow component corresponding to the user interface element.

18. The method according to claim 17, wherein the network message is configured according to the message component for containing the data entities based on the structured definition language.

19. The method according to claim 18 further comprising the step of sending a response network message containing message data related to the data entities, the response network message configured for subsequent presentation of the message data on a user interface of the communication device.

20. The method according to claim 19, wherein the message data is formatted based on the structured definition language.

21. A mobile communication device configured for interacting over a network with a web service using an executable version of a component application program including a plurality of components, the device comprising;
a device infrastructure for operating the mobile device including a processor and an associated memory for executing the executable version;
a user interface coupled to the device infrastructure having an input device and an output device configured for communication with the executable version;
a wireless transceiver coupled to the device infrastructure and configured for communicating with the network; and
a runtime environment for coordinating execution of the executable version for configuring the device as a web client of the web service, the runtime environment configured for interaction with a first set of the components having descriptors expressed in a structured definition language and a second set of the components being expressed as a series of instructions;
wherein the execution of the executable version provides for a subsequent exchange of information over the network between the web service and the communication device over the network.

22. The mobile communication device according to claim 21, wherein the runtime environment provides an interface for the executable version to the functionality of the processor and the associated operating system of the infrastructure of the communication device.

23. The mobile communication device according to claim 22, wherein the runtime environment is configured for implementing capabilities selected from the group comprising; provide communications for sending a network message to the web service, provide data input by a user of the device for supplying data content for a network message associated with the web service, provide data presentation in response to a network message associated with the web service, provide data storage services for maintaining local client data in a memory of the device, and provide an execution environment for a scripting language for coordinating operation of the components in the executable version.

24. The mobile communication device according to claim 22, wherein the runtime environment is configured as a portion of the operating system.

25. The mobile communication device according to claim 22, wherein the executable version is configured for sending a network message to the web service, the network message configured based on the structured definition language corresponding to at least one of the first set of components.

26. The mobile communication device according to claim 25, wherein the executable version is configured for receiving a response network message corresponding to the network message, the response network message for containing message data formatted based on the structured definition language, the response network message is configured for subsequent presentation of the message data on the user interface of the communication device.

27. The mobile communication device according to claim 22 further comprising a data component in the first set of component definitions, the data component for defining information to describe data entities used by the program and a format for the information.

28. The mobile communication device according to claim 27 further comprising a message component in the first set of component definitions, the message component for defining a format of messages used by the program to communicate over the network with the web service.

29. The mobile communication device according to claim 28, wherein the data component definitions and message component definitions are platform neutral for accommodating a variety of different runtime environments.

30. The mobile communication device according to claim 28 further comprising a presentation component in the first set of components, the presentation component for defining the appearance of the component application program as presented on the user interface of the device.

31. The mobile communication device according to claim 30, wherein the presentation component is platform specific for various predefined runtime environments.

32. The mobile communication device according to claim 30, wherein the structured definition language is based on eXtensible Markup Language.

33. The mobile communication device according to claim 30 further comprising a workflow component in the second set of components, the workflow component for defining processing that occurs when an action is to be performed as specified by one of the first set of components.

34. The mobile communication device according to claim 33, wherein the series of instructions for the workflow component is expressed in an object oriented programming language.

35. The mobile communication device according to claim 33, wherein the series of instructions for the workflow is expressed as a scripting language.

36. The mobile communication device according to claim 35, wherein the scripting language is based on ECMA Script.

37. The mobile communication device according to claim 33, wherein the executable version is configured for sending a network message initiated by interaction of a user of the communication device with a user interface element, the network message containing data entities created by the workflow component corresponding to the user interface element.

38. The mobile communication device according to claim 37, wherein the network message is configured according to the message component for containing the data entities based on the structured definition language.

39. The mobile communication device according to claim 38, wherein the executable version is configured for receiving a response network message containing message data related to the data entities, the response network message configured for subsequent presentation of the message data on the user interface of the communication device.

40. The mobile communication device according to claim 39, wherein the message data is formatted based on the structured definition language.

41. A computer program product for configuring a mobile communication device for interacting over a network with a web service using an executable version of a component application including a plurality of components, the computer program product comprising:
a computer readable medium;
a runtime environment module stored on the computer readable medium for coordinating execution of the executable version for configuring the device as a web client of the web service, the runtime environment configured for interaction with a first set of the components having descriptors expressed in a structured definition language and a second set of the components being expressed as a series of instructions;
wherein the execution of the executable version provides for a subsequent exchange of information over the network between the web service and the communication device over the network.

42. A server configured for providing a web service for interacting with a mobile communication device over a network, the server comprising:
a network interface for receiving a request network message to establish communication between the web service and the communication device;
a component application program coupled to the network interface for sending in response to the request network message, the component application program including a plurality of components, a first set of the components having descriptors expressed in a structured definition language and a second set of the components being expressed as a series of instructions, the components being configured for provisioning by a runtime environment of the communication device to produce an executable version of the component application program configuring the device as a web client of the web service;
wherein execution of the executable version provides for a subsequent exchange of information over the network between the web service and the communication device.

43. A mobile communication device configured for interacting over a network with a web service using an executable version of a component application program including a plurality of components, the device comprising;
an infrastructure means for operating the mobile device to execute the executable version;
a user interface means coupled to the infrastructure means configured for communication with the executable version;
a transceiver means coupled to the device infrastructure and configured for communicating with the network; and
a runtime means for coordinating execution of the executable version for configuring the device as a web client of the web service, the runtime means configured for interaction with a first set of the components having descriptors expressed in a structured definition language and a second set of the components being expressed as a series of instructions;
wherein the execution of the executable version provides for a subsequent exchange of information over the network between the web service and the communication device over the network.
